(19) United States
(12) Patent Application Publication
(10) Pub. No.: US 2005/0060707 A1
(43) Pub. Date: Mar. 17, 2005

(54) Method for iterating through elements of a collection

(76) Inventor: William Patrick Tunney, Montreal (CA)

Correspondence Address: KENYON & KENYON, 1500 K STREET, N.W., SUITE 700, WASHINGTON, DC, 20005, US

(21) Appl. No.: 10/663,758

(22) Filed: Sep. 17, 2003

(51) Int. Cl. G06F 9/46

(52) U.S. Cl. 718/100

(57) ABSTRACT

A method for iterating through elements of a collection. An embodiment of a method includes receiving a call to iterate through a collection that includes uninstantiated elements, instantiating, after receiving the call, the uninstantiated elements to provide instantiated elements, and iterating through the instantiated elements. An exemplary implementation includes iterating through messages in a file.

### BACKGROUND

A typical iterator interface provides a framework for iterating through a collection of elements in computer memory. The iterator interface defines a programming API that includes routine names and procedure definitions that all iterator implementers must obey. The iterator interface allows a developer the freedom to decide how to implement an iterator on the collection elements for any purpose, as long as those decisions do not violate the routine names and procedure definitions of the iterator interface.

An example is the Java™ Iterator interface developed by Sun Microsystems, which provides for iterating through, retrieving, and deleting elements from a collection in memory. Since iterators are generally applied to objects, the elements to which the Java™ Iterator is applied are Java™ objects. One concern with the Java™ Iterator is that it can only iterate through Java™ objects that already exist in memory prior to the calling of the Java™ Iterator. So the developer must instantiate the objects and put them together in a collection in memory prior to running the Java™ Iterator. Depending on program constraints, this may place an unnecessary programming burden on the developer.

Another concern involves application startup time. In any application, there is a noticeable amount of lag when the application starts up due to memory allocation and data initialization. This is particularly true for Java™ applications since, in most cases, the application must be instantiated by a Java™ Virtual Machine which itself must be instantiated. This is also apparent because Java™ is an interpreted rather than compiled language. In particular, one of the most expensive performance penalties in Java™ is Java™ object instantiation. For a Java™ Iterator application, this initial instantiation may increase the startup lag.

Accordingly, there is a need in the art for a method to iterate through collection elements that can be instantiated during runtime, thereby saving time and effort for the developer or user.

### SUMMARY OF THE INVENTION

Embodiments of the present invention provide a method for iterating through elements from a collection. The method provides receiving a call to iterate through a collection of uninstantiated elements. After receiving the call, the method instantiates and iterates through the uninstantiated elements.

The method advantageously provides iteration that is transparent to the developer, such that the developer need not instantiate the uninstantiated elements in memory prior to running the iteration routine.

### BRIEF DESCRIPTION OF DRAWINGS

FIG. 1 is an illustration of an embodiment of a method according to the present invention.

FIG. 2 is a flowchart of an embodiment of a method according to the present invention.

FIG. 3 is an illustration of the instruction flow between components of an exemplary implementation of the present invention.

FIG. 4 is a UML diagram illustrating an exemplary implementation of the present invention.

FIG. 5 is an exemplary computer used for implementing embodiments of the present invention.

### DETAILED DESCRIPTION

Embodiments of the present invention provide a method for iterating through elements in a collection by instantiating, during iteration program execution, element objects encapsulating the collection elements. These embodiments advantageously simplify implementation for the developer or user and improve flexibility of element iterators.

An element iterator is used to implement embodiments of the present invention. The iterator represents an object-oriented class that implements the Java™ Iterator interface. The iterator class implements the routine names and procedure definitions of the Java™ Iterator and builds on the Java™ Iterator framework to provide more powerful and flexible element retrieval routines by instantiating element objects during runtime. Since an iterator is generally implemented to iterate through objects, i.e., instantiated elements, the element iterator of the present invention takes uninstantiated elements of the collection and wraps or encapsulates them in a higher level of abstraction; hence, the instantiation of the collection elements into element objects.

The instantiated element objects of a currently-running implementation of the Java™ Iterator already exist within the Java™ iterator program scope, i.e., the element objects are already visible to the iterator program for iteration. In contrast, element objects in embodiments of the present invention need not be instantiated until after the element iterator is called. Instead, the element iterator is able to iterate through uninstantiated elements in the collection by dynamically instantiating element objects that encapsulate the elements as the iterator goes. Thus, the developer need not create the element objects in memory beforehand, saving the developer time and effort.

Exemplary collections to which the iterator of embodiments of the present invention may be applied may include a file, a data buffer or register, an array, a database, a web page, and like memory structures. Exemplary elements may include file messages, fields in database tables, links on a web page, serialized objects, and the like. Exemplary element objects may include arrays, class objects, hash tables, and any like representation capable of encapsulating collection elements and being iterated therethrough.

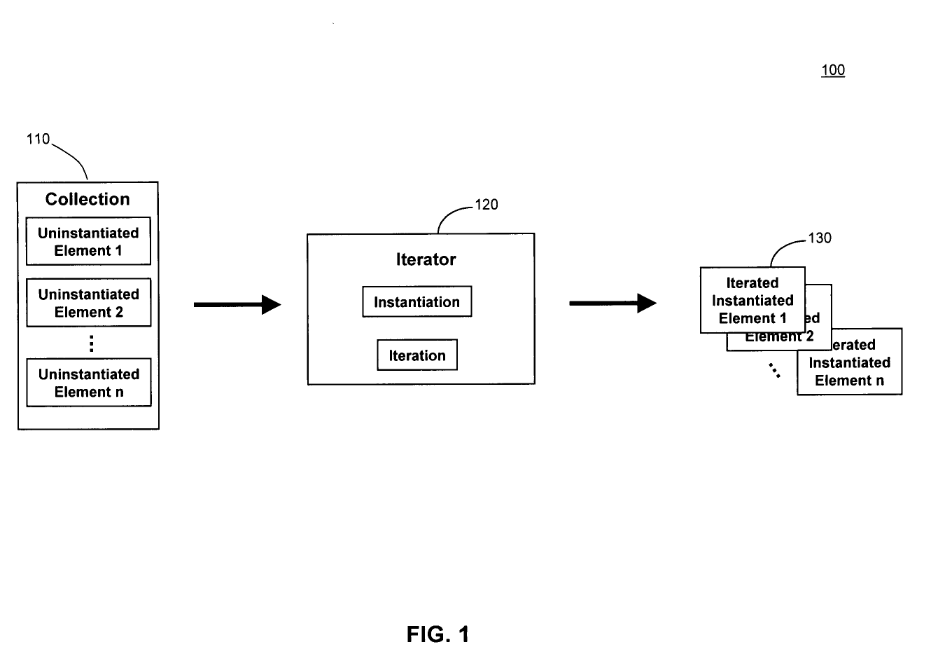

FIG. 1 is an illustration of a method of an embodiment of the present invention. This figure provides an overview of how the iterator performs its iteration of collection elements. An iterator 120 may receive a collection 110 of uninstantiated elements. The iterator 120 may then read one or more of the uninstantiated elements from the collection 110 and use an instantiation routine to create instances of the collection elements. The iterator 120 may then use an iteration routine to iterate through the instantiated elements. The result is iterated instantiated elements 130 that may now be further operated on by the iterator 120 or provided to another routine, for example.

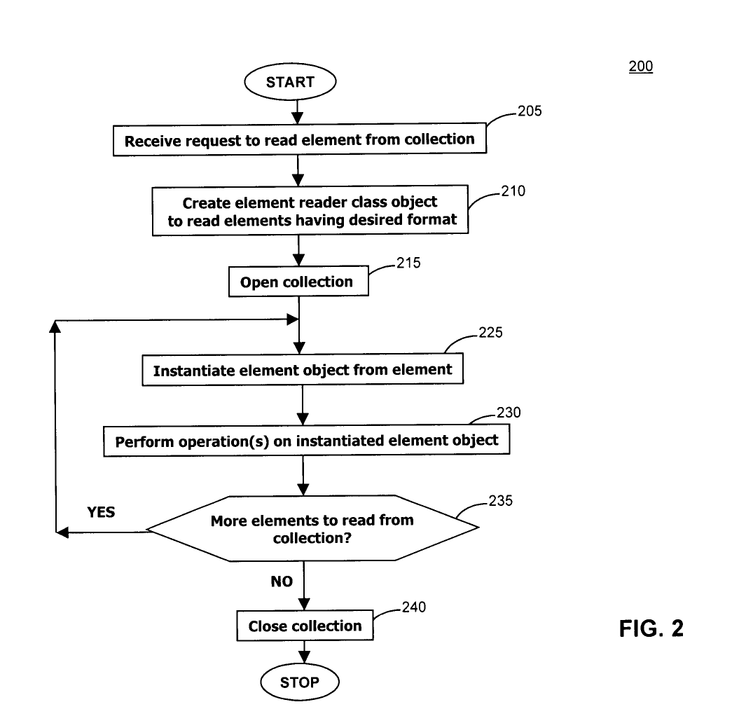

FIG. 2 is a flowchart of a method of an embodiment of the present invention. A computer processor may receive (205) a request from a user or a program to iterate through an element in a collection, after which the processor may call the element iterator. The element iterator may then call a factory routine to create (210) the appropriate object that can read the format of the requested element. A factory routine is a common method used to create anonymous object types that fulfill the requirements of an interface, in this case, the element iterator. Stored in memory may be a plurality of reader classes that define the routines needed to read multiple element formats. Accordingly, the element iterator may select the reader class having the routines for reading the desired element format and then create an instance, or object, of the selected reader class.

The factory routine may identify the desired element format in any known manner. For example, when reading elements from a file, in a Windows system, the common method to determine the format of elements in the file is by reading the file extension. In earlier Macintosh systems, a common method is by reading a few bytes at the beginning of the file. The factory routine may take the collection identifier, e.g., the filename, as an input parameter and then, after inspecting the parameter, find the appropriate reader class, instantiate a reader object, and return the object to the element iterator.

After the reader object associated with the desired element format has been created (210), the reader object may then open (215) the collection. The reader object may then read the element from the collection and instantiate (225) an element object to encapsulate the read element. Until this point, the element object of the read element had not existed in memory. The reader object may then return the element object and program control to the element iterator.

After the reader object instantiates (225) the element object and returns it to the element iterator, the element iterator may perform (230) the appropriate operation on the returned element object, which may include passing the returned element object to the requesting user or program. Optionally, after iterating through the element, the element iterator may remove the element from the collection. If there are other elements in the collection to be iterated through (235), the element iterator may repeat the iteration process (225, 230). Otherwise, the element iterator may close (240) the collection.

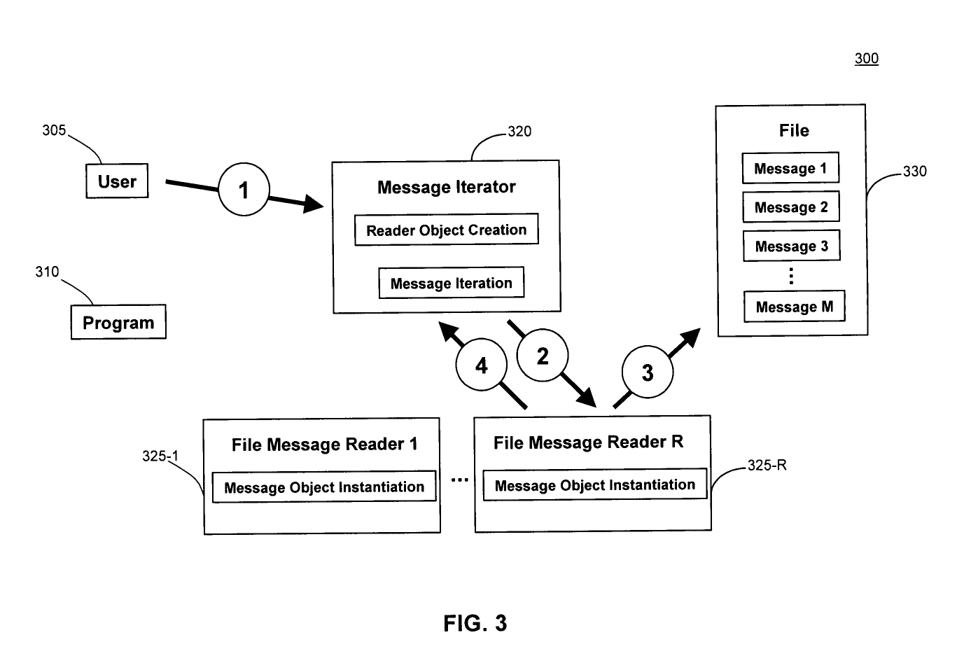

FIG. 3 is an illustration of the instruction flow between components of an implementation of the element iterator when applied to file messages. This embodiment may include, but is not limited to, a user 305, an input program 310, a message iterator 320, which refers to the element iterator, one or more file message readers 325, which refer to the reader classes, and a message file 330, which refers to the collection. The message iterator 320 may interact with the user 305, program 310, file message readers 325, and message file 330 directly or indirectly in order to provide a method for reading file messages according to embodiments of the present invention. The message iterator 320 may accomplish this by message iteration and reader object creation. Message iteration may implement the Java™ Iterator and tailor it to iterate through the instantiated messages in the file 330. Reader object creation may determine the file message reader class particularly suited to read the messages in the file 330 and then create a reader object of that determined file message reader class.

Each file message reader class 325 may include a routine to read messages with a particular format from the file 330 and instantiate message objects, i.e., the element objects, that encapsulate the messages, i.e., the collection elements. Each file message reader class 325 may implement the message reader interface and tailor it to instantiate messages having a particular format from a file. Accordingly, for a plurality of different message formats, there may be a corresponding plurality of file message readers 325. Message object instantiation may read the desired message and instantiate a message object to be returned to the message iterator 320.

In FIG. 3, the message iterator 320 may receive (1) a request for a file message from the user 305. An exemplary request may be “Start iteration through the messages in file X by retrieving the first message.” Alternatively, the message iterator 320 may receive a request from another program 310.

Upon receiving the request, the message iterator 320 may call the factory routine to determine (2) the file message reader class 325 to use in order to iterate through the desired messages. The factory routine may then create the reader object of the file message reader class 325, which then reads (3) the desired message from the file 330 and instantiates a message object. In an exemplary implementation, the message may be read into an array, wherein the array becomes the instantiation of the message. The instantiated message object may be sent (4) to the message iterator 320 for further processing, which may include passing the message object to the requesting user 305 or program 310. The message iterator 320 may iterate through the instantiated message objects for as many messages as desired.

An alternate implementation includes retrieving links from a web page. For example, the web page may include a collection of links that the element iterator may retrieve by using a web page link reader class to cause the web page to be opened and to result in the parsing of the web content to find and retrieve the links therein. In this implementation, the element iterator may cause web link objects to be instantiated and then iterated through to retrieve a desired web site. Another implementation includes retrieving data from database tables. Here, the element iterator may use an SQL database table reader class to cause an SQL statement to be executed, including inputting database tables, instantiating the data from the tables, iterating therethrough, and returning an instantiated data object.

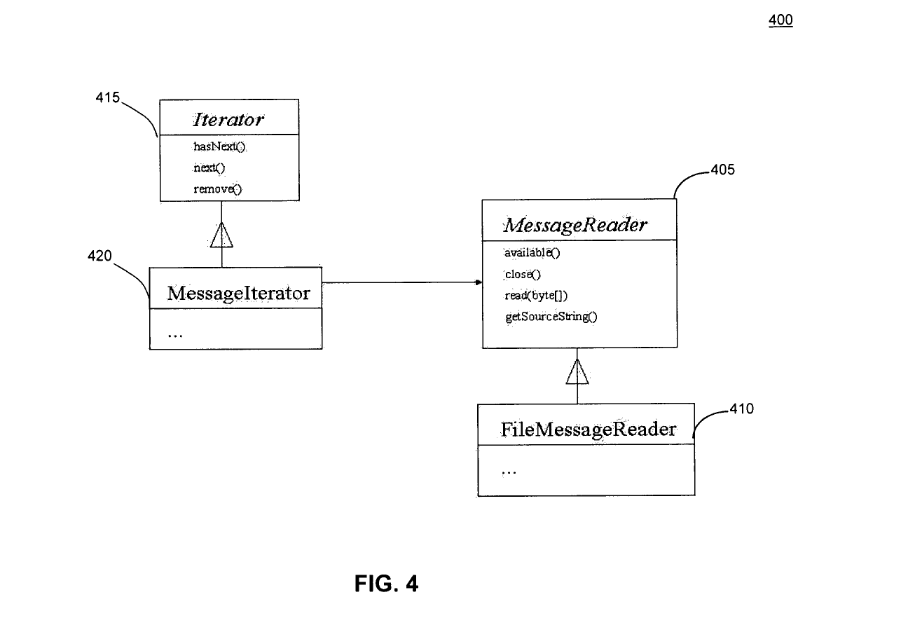

FIG. 4 is a UML diagram of an exemplary implementation of a message iterator. The figure illustrates how the components of the message iterator implementation interact with each other to provide a method for iterating through messages in a file. The components of this implementation include the Java™ iterator interface 415, the message iterator class 420, the message reader interface 405, and at least one file message reader class 410.

The Java™ Iterator interface 415 comprises the following exemplary routine names and procedures: hasNext( ), which indicates whether there are more elements available in the collection, next( ), which obtains the next element from the collection, and remove( ), an optional operation which removes the last obtained element from the collection.

The message reader interface 405 may include routine names and procedures that enable a retrieval program to retrieve elements from a collection, independent of knowledge about the collection. The following exemplary routine names and procedures may be used: getSourceString( ), which retrieves a collection identifier, e.g., a filename, available( ), which determines if there are more elements in the collection, read( ), which reads an element from the collection and instantiates it into an element object, and close( ), which indicates that the collection should be closed.

The file message reader class 410 may implement the message reader interface 405. In this class 410, the routine names and procedures of the message reader interface 405 may be defined including how to read a particular element format and how to instantiate element objects from the read elements. Embodiments of the present invention may include multiple file message reader classes 410, each class defining how to read a particular element format.

An exemplary routine defined by the class 410 to read a particular format may read a message format having a fixed header followed by message data. The message format may be [n-byte header][data], where n is an integer. The header may describe the data byte length, which may be determined by calculations on the header. The exemplary routine may perform the following operations: read the n-byte header using read( ), determine the byte length and other information about the data, read the data using read( ), and return the data to the calling routine.

Another exemplary routine defined by the class 410 may read a message format having delimiters that separate the messages. The message format may be [data][,], where the delimiter is a comma. The routine may perform the following operations: read the data using read( ), identify the delimiter, return the data read up until the delimiter to the calling routine. It may be understood that the delimiter is not limited to a comma, but may include any character, symbol, number, sequence of bytes, etc., identifiable as not belonging to the adjacent messages.

It may further be understood that the file message formats are not limited to those described above, but may include any such perceptible data patterns, both simple and complex.

The message iterator class 420 may implement the Java™ Iterator interface 415. In this class 420, the routine names and procedures of the Java™ iterator interface 415 may be defined, including how to iterate through elements in the collection. The message iterator class 420 may also include a factory routine to create an object from the file message reader class 410. Embodiments of the present invention may include multiple message iterator classes 420, each class defining how to iterate through different data sources.

Upon initialization of the exemplary implementation of FIG. 4, a developer or user or another program may designate the collection to be iterated through by the message iterator. A file message reader class 410 may link to the designated collection. The message iterator class 420 may associate with an instance of the file message reader class 410 to create an iterator abstraction that allows synchronously retrievable elements to be treated as a collection and thereby retrieved. The iterator abstraction may be maintained even if the element format changes. In this case, the file message reader class 410 may include a plurality of format definitions and corresponding routines to read the formats. Accordingly, the developer need only create an implementation of the message reader interface 405 at runtime.

In an alternate embodiment, a plurality of file message reader classes 410 may be defined, where each class may include one or more element format definitions and corresponding routines to read the formats. In this case, for a desired file message format, the developer need only create a new implementation of the message reader interface 405 having the desired element format and swap the new implementation with the current instance of the file message reader class 410 at runtime.

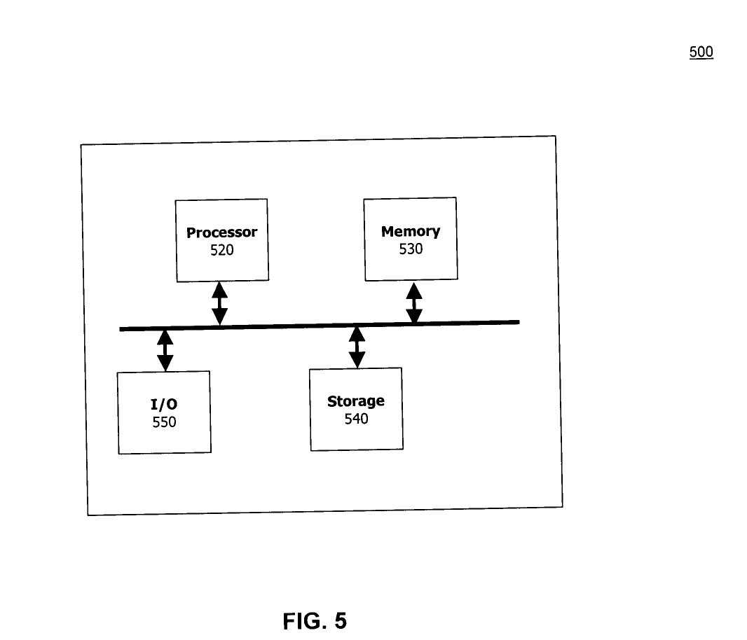

FIG. 5 is a block diagram of an exemplary computer that can implement embodiments of the present invention. The computer 500 may include, but is not limited to, a processor 520 provided in communication with a system memory module 530, a storage device 540, and an I/O device 550. The processor 520 may perform the message retrieval from the file. The memory 530 may store program instructions to be executed by the processor 520, variable data generated pursuant to program execution, and collections. In practice, the memory 530 may be a memory system including one or more electrical, magnetic, or optical memory devices. The I/O device 550 may receive input from and display output to the developer or user.

Embodiments may be implemented using a general-purpose microprocessor programmed according to the teachings of the embodiments. The embodiments of the present invention thus also includes a machine readable medium, which may include instructions used to program a processor to perform a method according to embodiments of the present invention. This medium may include, but is not limited to, any type of disk including floppy disk, optical disk, and CD-ROMs.

It may be understood that the structure of the software used to implement the embodiments of the invention may take any desired form, such as a single or multiple programs. It may be further understood that the method of an embodiment of the present invention may be implemented by software, hardware, or a combination thereof.

The above is a detailed discussion of the preferred embodiments of the invention. The full scope of the invention to which applicants are entitled is defined by the claims hereinafter. It is intended that the scope of the claims may cover other embodiments than those described above and their equivalents.

1. A method comprising:
receiving a call to iterate through a collection including at least one uninstantiated element;
after receiving the call, instantiating the uninstantiated element to provide an instantiated element; and
iterating through the instantiated element.

2. The method of claim 1, further comprising:
implementing an interface having routines for iterating through the collection.

3. The method of claim 1, further comprising:
implementing an interface having routines for instantiating the uninstantiated element based on the format of the uninstantiated element.

4. The method of claim 1, further comprising:
determining whether the uninstantiated element is available in the collection.

5. The method of claim 1, wherein the collection is a file and the uninstantiated element is a file message.

6. The method of claim 1, wherein the collection is a web page and the uninstantiated element is a web link.

7. The method of claim 1, wherein the collection is an SQL database table and the uninstantiated element is a database field.

8. A method comprising:
after receiving a call to iterate through raw data, generating data elements from the raw data, wherein the data elements can be iterated through; and
iterating through the data elements.

9. The method of claim 8, wherein the data elements are generated based on the format of the raw data.

10. A method comprising:
receiving an instruction to iterate through a file including at least one message;
determining to which of a plurality of predefined formats the message belongs;
instantiating the message using a routine associated with the determined format of the message; and
iterating through the instantiated message.

11. The method of claim 10, further comprising:
determining whether the file includes subsequent messages to be retrieved; and if so,
retrieving a next message using a routine associated with the determined format, and
optionally, removing the next message from the file.

12. The method of claim 10, further comprising:
opening the file;
determining whether the message is available from the file; and
closing the file after the message has been retrieved.

13. The method of claim 10, wherein the predefined formats are transparent to a user.

14. The method of claim 10, wherein the predefined formats include a fixed length header and data bytes.

15. The method of claim 14, wherein the routine includes:
reading the fixed length header from the file;
calculating an integer value of the fixed length header;
reading the data bytes disposed in the file after the fixed length header, the number of read data bytes corresponding to the integer value; and
returning the read data bytes as the message.

16. The method of claim 10, wherein the predefined formats include delimiters separating data bytes.

17. The method of claim 16, wherein the routine includes:
reading the data bytes until a delimiter is reached; and
returning the read data bytes as the message.

18. The method of claim 10, further comprising:
receiving an instruction to iterate through an empty file; and
returning an indication that the empty file does not include any messages.

19. A machine readable medium containing program instructions for execution on a processor, which when executed by the processor, cause the processor to perform:
calling a message reader object to iterate through a collection;
creating a file message reader object to determine the format of an element in the collection;
using the file message reader object to read the element from the collection; and
after the calling the message reader object, using the file message reader object to create a message object from the read element.

20. The machine readable medium of claim 19, wherein the file message reader object includes a routine to retrieve the element from the collection and create the message object from the retrieved element.

21. The machine readable medium of claim 19, wherein the message iterator object includes a first routine to create the file message reader object and a second routine to iterate through the collection.

22. The machine readable medium of claim 19, wherein the format includes a fixed length header and data bytes.

23. The machine readable medium of claim 19, wherein the format includes delimiters separating data bytes.

24. The machine readable medium of claim 19, further comprising:
determining the format of the element during the execution by reading at least a portion of the element and evaluating the portion.

25. A method comprising:
responsive to a request to read an element from a collection, creating a reader object based on the format of the element;
opening the collection;
after receiving the request,
using the reader object, instantiating an element object including the element, and
performing an operation on the element object; and closing the collection.

26. The method of claim 25, further comprising:
repeating the instantiating the element object and performing if there are additional elements available to be read from the collection.

27. The method of claim 25, further comprising:
removing the element from the collection after the instantiating or the performing.
